(19) United States
(12) Patent Application Publication
(10) Pub. No.: US 2009/0018975 A1
(43) Pub. Date: Jan. 15, 2009

(54) METHOD FOR ESTABLISHING A COMMERCIAL REAL ESTATE PRICE CHANGE INDEX SUPPORTING TRADABLE DERIVATIVES

(75) Inventors: David Geltner, Carlisle, MA (US); Henry O. Pollakowski, Belmont, MA (US)

Correspondence Address: CHOATE, HALL & STEWART LLP, TWO INTERNATIONAL PLACE, BOSTON, MA, 02110, US

(73) Assignee: MASSACHUSETTS INSTITUTE OF TECHNOLOGY, Cambridge, MA (US)

(21) Appl. No.: 11/775,401

(22) Filed: Jul. 10, 2007

(51) Int. Cl. G06Q 40/00

(52) U.S. Cl. 705/400

(57) ABSTRACT

Method for establishing a commercial real estate price change index supporting tradable derivatives. The method utilizes a database of price changes actually experienced by individual commercial properties including allowing for gradual accumulation of price data. The database is filtered with selected data filters and time-weighted dummy variables are specified. A repeat-sales regression is performed on the filtered database to create the index. The repeat-sales regression includes a weighted least squares estimation in which weights are determined in a three-stage regression process. A ridge regression noise filter in which a first order autocorrelation coefficient in estimated index price-change returns controls the ridge estimation, and the first autocorrelation coefficient is near 0. The index is optimized for derivative trading purposes by excluding backward adjustments and a scope and frequency for the index is selected. The index may be used for tradable derivatives.

This invention relates to establishing a commercial real estate price change index that is specifically engineered for tradable derivatives.

### BACKGROUND OF THE INVENTION

The real estate and investment industry in the U.S. has become very interested in the possibility of developing tradable derivatives to allow trading of commercial real estate futures prices, such as by the use of price index return swaps, based on commercial (investment) property price movements. Such derivatives could revolutionize the real estate investment industry, as they have already done in other sectors of the capital markets. A futures market for commercial property could, at least in theory, greatly increase the efficiency of the real estate industry by allowing greater specialization among the various players in the traditional real estate investment business, including investors, developers, property owners, fund managers, mortgage lenders, and others. Index return swaps could address long-standing problems with real estate investment, such as high transactions costs, lack of liquidity, inability to sell “short”, and difficulty comparing investment returns with securities such as stocks and bonds.

Real estate represents over one-third of the value of all investable assets in the U.S., by far the largest segment of underlying physical capital for which virtually no derivative assets have existed in the capital markets. Historically, real estate markets have been prone to boom-and-bust cycles, bouts of overbuilding, and cyclical price swings. One reason for this may be the lack of derivative assets that could facilitate rapid multi-directional money flows and price discovery. User/owners of real estate have been unable to hedge their exposure to real estate market risk over which they have no control, and potential real estate investors have been deterred by the frictions of direct transactions in the property market. Derivatives could address these problems.

In recent years the development of electronic data sources on commercial property transaction prices in the U.S. has allowed a new type of database to be developed relevant to tracking commercial property price changes. A leader in the development of this type of database is the firm Real Capital Analytics, Inc. (RCA) of New York. RCA endeavors to collect the prices of every commercial property transaction of more than $2,500,000 in the U.S.—a vastly larger potential population than the National Council of Real Estate Investment Fiduciaries database, covering in essence the entire $2.5 trillion U.S. investable property universe. RCA also takes great care to check and ascertain the accuracy of the transaction price data they obtain, and they have made a major effort to collect data on not only the current but also the prior sale price of transactions they track, thereby making possible a “repeat-sales” database of same-property price changes.

Tracking property price movements in an up-to-date manner comparable to the way stock and bond price indexes track the movements of those other major asset classes has long been a goal of both academic and industry researchers focusing on real estate investments. The fundamental problem is that property assets trade in private search markets rather than public securities exchanges. As a result, transaction price data in real estate pertains to individual whole assets each of which is unique and traded in a private deal between one buyer and one seller. The individual assets (properties) trade infrequently and irregularly through time.

Simply comparing the average price (say, per square foot) of the properties sold in one period with that of the properties sold in the previous period does not present a very good measure of how property prices have changed between the two periods, from the perspective of the experience of a property investor. Consider the following points.
The properties that sold last period are not the same properties as the ones that sold this period, so you are comparing “apples vs oranges”.
It is likely that the average quality of the properties traded one period will be different from the average quality of the properties traded the next period. If the price/SF last year was $100 and this year it's $110, is that because the market price moved up 10%, or because the properties that sold this year happened to be of 10% higher (more valuable) quality than those that sold last year (e.g., better buildings, better locations . . . )?
Changes in property quality may be random, in which case they will introduce extra “noise” (hence, basis risk from a hedger's perspective) into a simplistic price/SF index.
Or changes in property quality may be systematic, in which case they will introduce bias into the index. For example, there is evidence of a sort of “flight to quality” when markets turn down, at least among institutional investors. Better quality properties tend to sell disproportionately when the market turns down. The result could be an upward bias in down markets, and a downward bias in up markets, in a simplistic price/SF index.
There are systematic differences between simple average price indexes and actual property price changes. Perhaps the most notable such difference has to do with property aging, and the natural real depreciation of buildings. The average age of buildings transacting in one period does not tend to be older than the average age of buildings transacting in the previous period, simply because the building stock in a given market tends to renew itself as old buildings are “retired” (in various ways) and new buildings are built. But real estate investors own specific buildings. Every one of these buildings is one year older today than it was a year ago. Age affects property value, even after normal capital improvement expenditures are applied to keep up the buildings. Functional and economic obsolescence cannot be mitigated by routine capital improvement expenditures. (For example, how many 40-year-old hotels have multi-story atrium lobbies? How many 40-year-old office buildings can charge “Class A” rents unless they have had recent major rehab investments?) Real depreciation of the structure is not reflected in a simplistic price/SF index, but real investors in real properties are fully subject to the effect of such depreciation.

The result is that, for tracking the property price movements that matter to investors, simplistic average price/SF indexes suffer from both bias and random error (inducing “noise” into the index). The nature of this error and bias is difficult to quantify and analyze precisely or rigorously. This turns “risk” into “uncertainty” (the former is quantifiable, the latter is not), that is, it turns something the capital markets can handle into something the capital markets shun.

For the above reasons, most serious real estate academics and econometricians do not view simplistic average price indexes as sufficiently rigorous for the purpose of tracking the property price movements that matter to property investors.

An alternative approach that has been used in the institutional branch of the real estate investment industry is to base the index on regular and frequent appraisals of a specified set of properties. This is the approach of the NCREIF Property Index (NPI), published by the National Council of Real Estate Investment Fiduciaries. While such an appraisal-based index can be very useful for some purposes (e.g., benchmarking investment manager performance), the shortcomings of relying uniquely on such an index to support commercial property price derivatives in the U.S. are problematic. This leads us to the quest for a valid, quality-controlled transactions price based methodology for building a commercial property price index to support derivatives trading.

Over the past several decades the academic real estate community has developed methodologies that are much more rigorous and sound for constructing transactions-based property market periodic price-change indexes, based on regression analysis. Broadly, there are two major approaches, both aimed at addressing the fundamental problem of controlling for differences in the “quality” of the properties transacting in adjacent periods of time, while also minimizing random error (“noise”).

One approach is referred to as “hedonic” regression. In this approach property prices are modeled as reflecting a bundle of individual property and transaction attributes (or “hedonic characteristics”), such as location, age, size, building quality, tenant/lease quality, type of buyer and seller, etc. In principle, if the regression model can adequately capture all of the factors that affect property value, then it can control for differences in the transacting properties' “quality” across time, for example by basing the index on a defined “representative property” and “representative transaction”. However, the hedonic approach can be much more difficult to apply to commercial property than to housing, because of the heterogeneity and relative scarcity of commercial properties relative to houses in the U.S. The need for large quantities of consistent and high quality hedonic data about the characteristics of the properties and the transactions presents a formidable obstacle in the context of broad, real-time databases such as that of RCA.

It can be possible to successfully overcome the hedonic data challenge for commercial property if there exists a high-quality “catch-all” hedonic variable, such as regularly updated appraisals of all the transacting properties. (The appraisal reflects all of the “hedonic” characteristics of each property that affect its value, thereby adequately controlling for cross-sectional differences in the transacting properties.)

The other approach to producing quality-controlled property price indexes is arguably the oldest and most widely-used method. This is known as the “repeat-sales regression” (RSR) technique. In an RSR index, the database on which the regression is estimated consists purely of properties that transact at least twice in the historical sample. See, M. Bailey, R. Muth, & H. Nourse; “A Regression Method for Real Estate Price Index Construction”, Journal of the American Statistical Association 58: 922-942, 1963. The fundamental data on which the index is based thus consist of the price changes actually experienced by individual properties, the same type of price changes as direct property investors actually experience, as such investors themselves own individual properties. The regression allocates those price changes to individual periods of time in an optimal manner (where “optimal” is defined in a rigorous manner based on econometric principles). The RSR index might therefore also be described as a “same-property price-change index”. As such, it is fundamentally comparable to typical securities indexes, such as stock market indexes, which are based on same-stock price changes from one period to the next.

The RSR methodology underlies the two major quality-controlled transactions-based property price indexes regularly published in the U.S. to date. Both of these track the housing markets: The Fannie Mae and Freddie Mac based “Conventional Mortgage Home Price Index” (CMHPI) published by the Office of Federal Housing Enterprise Oversight (OFHEO); and the privately produced Case-Shiller-Weiss (CSW) housing price indexes. It is this latter index that the recently-introduced CME housing futures contracts are based on.

In addition, a number of quality-controlled transactions-based indexes have been published in the academic literature. Most of these are based on housing market data, and most are focused on the academic purpose of exploring different methodologies for inferring market price movements, or studying the historical behavior of property markets. None of the real estate price indexes published to date in the academic literature have been developed from the outset specifically or primarily for the purpose of supporting tradable commercial property price derivatives.

An objective of the present index development invention has been to use the opportunity afforded by the RCA transactions prices database to fill the above-noted gap. That is, we have sought to develop a set of quality-controlled transactions price based commercial property indexes designed from the outset specifically and primarily for the purpose of supporting tradable derivatives. In that sense, this invention is not an academic exercise, but a de novo effort to engineer a practical product that will be useful in the marketplace. With this goal in mind, the following specific objectives and criteria have been enunciated.
i. Contemporaneous Quality-Controlled Indexes. The index methodology should control for differences in the quality of properties transacting in different periods of time, and it should be as up-to-date as possible, avoiding insofar as possible temporal aggregation and temporal lag bias.
ii. Simplicity and Transparency. The index construction methodology should adhere insofar as possible to widely-used, conventional techniques of quality-controlled transactions price based indexes that are well established within the academic real estate community, and within the realm of rigorous econometric methodology should be as simple and easy to understand as possible. This includes development and use of simple, easy-to-understand, data-filtering rules to control against development projects, “flips”, and data errors.
iii. Same-Property Price-Change (“repeat-sales”) Indexes. After an analysis comparing the hedonic and repeat-sales approaches within the RCA database, it was decided to base the indexes disclosed herein on the repeat-sales regression (RSR) approach. In side-by-side comparisons, the RSR indexes behaved better than hedonic indexes of the same markets. Controlling for institutional investor sales, the RCA-based RSR index tracked better the previously-published TBI based on NCREIF sales than an RCA-based hedonic index did, even though the TBI is itself a hedonic index (making use of the NCREIF appraisals as a high-quality catch-all hedonic variable). Furthermore, as noted, repeat-sales indexes have the appealing feature that they are based fundamentally on the same type of price changes as are directly experienced by actual property investors, namely, same-property price changes. And repeat-sales indexes avoid the major specification questions that would surround any specific hedonic model that might be chosen (i.e., which hedonic variables should be included? which ones are missing or unreliable in the data? How shall a “representative property” be defined? etc.). As repeat-sales indexes, the indexes disclosed herein should be viewed, in effect, as tracking “same-property price-changes”, including the effect of routine capital improvement expenditures on the property prices.
iv. Realized Price Changes Only (no backward adjustments). Going forward from the time trading on the indexes becomes available, the index construction methodology should reflect only the price changes implied by realized investments (that is, round-trip investment price-change returns, as indicated by contemporaneous second sales during the subject time period, up to and including but not going beyond the contemporary time period). This results in indexes that, once a short preliminary phase for contemporaneous data accumulation is over, will be effectively “frozen” for each historical period of time, thus eliminating the problem of “backward adjustments” presented by academic price-change indexes that are designed for research purposes. Under the premise that fast trumps correct, a major tendency of the financial markets suggests that financial instruments that are based on promptly reported data, even when such data is perceived by the market as being inaccurate, often experience substantial levels of trading activity. To illustrate an example, the Bureau of Labor and Statistics (BLS)'s Monthly Employment Report is understood to be a vague approximation, imprecise by a large margin, and will be revised the following month. However, trading off of it when first issued is customary, even though the first mark of this indicator is well known to be short in quality. On the contrary, contracts that rely on past reported, or backwardly-adjusted, prices tend to become uninteresting trading tools. The Case-Shiller housing indices, for example, have enjoyed minimal liquidity since were first listed at the Chicago Mercantile Exchange. Thus, in practice it would not be possible to include much backward adjustments in any given traded contract.
v. A Premium on Market-Specific Indexes. The set of published and tradable indexes to be developed should recognize the value and utility the market places on market-specific indexes, that is, indexes that are as narrowly defined as possible in terms of property type sectors and geographic market definition. To this end, the set of indexes will “drill down” as far as possible into specific property types and geographical areas, consistent with the preceding criteria and objectives, and protocols will be established for the contingency of periods when such specific indexes do not have sufficient data to publish.
vi. Use of Noise Filtering. Consistent with the foregoing objectives, the index methodology will make use of noise-filtering methodology that does not induce a temporal lag bias, in order to make the indexes as precise as is reasonably possible given the amount of data available.

The result of these six objectives and criteria for engineering the indexes can be described succinctly as a transactions-based “Same-Property Realized Price-Change Index”. The specific methodology of the index construction is described in detail and explained below.

### SUMMARY OF THE INVENTION

In one aspect, the invention is a method for establishing a commercial real estate price change index supporting tradable derivatives including utilizing a database of price changes actually experienced by individual commercial properties including allowing for gradual accumulation of price data. The database is filtered with selected data filters and time-weighted dummy variables are specified. A repeat-sales regression is performed on the filtered database to create the index. The repeat-sales regression includes a weighted least squares estimation in which weights are determined in a three-stage regression process. A ridge regression noise filter is provided in which a first order autocorrelation coefficient in estimated index price-change returns controls the ridge estimation and the first order autocorrelation coefficient is near zero. The index is optimized for derivative trading purposes by excluding backward adjustments and a scope and frequency for the index is selected.

In a preferred embodiment, the data filters are selected from the group comprising flips filter, portfolio transactions, excessively old data, incomplete information, consistent usage, built before first sale, no major change in size, and extreme returns filter. In another preferred embodiment, the dummy variables assume values between 0 and 1. In this embodiment, the time-weighted dummy variable has a value equal to the proportion of the period of time during which a property was held by an investor between two sales.

It is preferred that the three stage regression process include running an ordinary least squares regression and finding residuals from the regression. These residuals are squared and a second regression is performed on the squared residuals. The slope parameter from the second regression is estimated (with the intercept parameter constrained to be 0) and the estimated slope parameter is used to weight the original repeat-sales observations in performing a third-stage weighted least squares regression. In another preferred embodiment, the ridge regression noise filter appends a small amount of synthetic data to actual empirical data thereby providing an anchor to periodic price change estimates. It is also preferred that the price change index reflect only price changes implied by realized investments thereby eliminating a problem of backward adjustments.

In another preferred embodiment, the method further includes publishing four staggered seasonal versions of an annual index. And in yet another preferred embodiment, the price-change indexes are accompanied by an indication of the approximate magnitude of the income return (current property net income as a fraction of property value) that may be useful for developing tradable derivative contracts.

### BRIEF DESCRIPTION OF THE DRAWING

FIG. 1. is a block diagram illustrating the steps of the method of the invention.

### DESCRIPTION OF THE PREFERRED EMBODIMENTS

First of all, the inventors will describe and explain the details of the price-change index construction methodology according to the invention. We will begin with a simple description and numerical example of the basic repeat-sales regression (RSR) technique that underlies the indexes. We will then describe some enhancements to this technique to improve the index's precision. Data filters that are employed will also be described.

To understand how the RSR index construction process works, you must step back briefly and recall some basic statistics. You may recall that regression analysis is a statistical technique for estimating the relationship between variables of interest. In a regression model, a particular variable of interest, referred to as the dependent variable, is related to one or more other variables referred to as explanatory variables. The regression model is presented as an equation, with the dependent variable on the left-hand-side of the equals sign, and a sum of terms on the right-hand-side consisting of the explanatory variables each multiplied by a parameter that is estimated by the regression and that relates each explanatory variable to the dependent variable. For example, if the dependent variable is labeled “Y” and there is a single explanatory variable labeled “X” then a simple regression model of Y as a function of X would expressed as:

Y=aX

The model says that the value of the variable Y equals the value of the variable X times the parameter “a”, and we would use the regression analysis of relevant empirical data to estimate what is the value of “a”. This process is referred to as “estimation” of the regression, or “calibrating” the model.

How can this technique enable the development of a real estate price index? Let's take a very simple numerical example. Suppose we want to estimate an index of the price changes in two consecutive periods of time, say, 2007 and 2008. And let's suppose that the actual, true price change during 2007 was 10%, and the actual, true price change during 2008 was 0% (no change). Now suppose we can observe transactions of two properties that each sell twice during the relevant span of time. Property #1 sells at the end of 2006 for $100,000, and again at the end of 2008 for $110,000. Property #2 sells at the end of 2007 for $220,000 and again at the end of 2008 for the same price, $220,000. These transaction price observations are depicted in the table below. Notice that this data provides us with two same-property repeat-sales observations, one from Property #1 (which sells in 2006 and repeats in 2008), and one from Property #2 (which sells in 2007 and repeats in 2008).

| | Prices Observed at Ends of Years: | | |
|---|---|---|---|
| | 2006 | 2007 | 2008 |
| Property # 1 | $100,000 | No Data | $110,000 |
| Property # 2 | No Data | $220,000 | $220,000 |

While you may be able to see that these prices are consistent with the true annual price changes that we stated above (10% during 2007 and 0% during 2008), you cannot directly derive these annual price changes simply by comparing the average prices observed in each year. Suppose you did not already know what the true price changes were (the situation in the real world), and you tried to derive them by comparing the average price in one year with the average price in the next year. The average observed price in 2006 is $100,000; in 2007 it is $220,000; and in 2008 it is $165,000 (the average between the $110,000 price of Property #1 and the $220,000 price of Property #2 in 2008). If we simply took the percentage change in these average prices each year, we would get 120% for 2007 (as $220,000 is 120% greater than $100,000), and negative 25% for 2008 (as $165,000 is 75% of $220,000). Obviously these changes are nothing like the true price change returns that actually happened in those two years.

Now let's apply the repeat-sales regression model to this problem. Let the dependent variable, “Y”, be the percentage price change in each same-property repeat-sales observation. Thus, the first repeat-sales observation, based on Property #1, has a Y value of 10%, given by the difference between that property's $110,000 sale price in 2008 and its earlier $100,000 sale price in 2006. Similarly, the second repeat-sales observation, based on Property #2, has a Y value of 0%, as its price did not change between its first and second sales in 2007 and 2008 respectively.

On the right-hand-side of our repeat-sales regression, instead of just one variable, “X”, let there be two variables, which we will label “X2007” and “X2008”. These right-hand-side variables are what are called “dummy variables”, which means they take on a value of either zero or one. The “X2007” variable stands for the year 2007. It takes the value of one if 2007 is after the year of the first sale and before or including the year of the second sale in the repeat-sales observation (in other words, if the dummy variable's year is during the property investor's holding period between when he bought and sold the property of the observation in question); otherwise this dummy variable has a value of zero. Similarly, “X2008” takes the value of one if 2008 is after the year of the first sale and before or including the year of the second sale. Thus, the price observation data in the previous table gives the repeat-sales regression estimation data in the table below.

| | RSR Estimation Data | | |
|---|---|---|---|
| | Y value: | X2007 value: | X2008 value: |
| Observation # 1 | 10% | 1 | 1 |
| Observation # 2 | 0% | 0 | 1 |

Our regression equation can now be expressed as:

Y=a₂₀₀₇(X2007)+a₂₀₀₈(X2008),

where “a₂₀₀₇” and “a₂₀₀₈” are the parameters that must be estimated to “calibrate” the regression model. These parameters represent the percentage price changes in each period.

Now recall from statistics that the estimation of a regression model, that is, the “calibration” of the value of the parameters in the above equation, is essentially the solution of a system of simultaneous equations. Each equation corresponds to one “observation”, one data point in the database used to estimate the regression model. Thus, in our present example, we have two equations, one corresponding to each row (each repeat-sales observation) in the above estimation data table. The two equations are:

10%=a₂₀₀₇(1)+a₂₀₀₈(1)

0%=a₂₀₀₇(0)+a₂₀₀₈(1)

Since anything times one is just itself, and anything times zero is zero, the above two equations are equivalent to:

10%=a₂₀₀₇+a₂₀₀₈

0%=a₂₀₀₈

We thus have two linear equations with two unknowns (the two parameters, a₂₀₀₇ and a₂₀₀₈, representing the price-change percentages in each of the two periods), and you can easily see just from inspection that the solution to these two equations is:

a₂₀₀₇=10%

a₂₀₀₈=0%.

Thus, the repeat-sales regression analysis allows us to derive the actual, true annual price changes for each year, 10% during 2007 and 0% during 2008, as the estimated values of the time-dummy variable parameters in the regression model. Note that we could derive the 10% capital return in 2007 even though we had no single property in the estimation database that was bought at the beginning of 2007 and sold at the end of 2007. Furthermore, our ability to estimate the two annual returns was not dependent on the fact that we did have one property that sold at the beginning and end of the other year, 2008. The effectiveness of the repeat-sales regression model depends in principle ONLY on their being at least one sale (either a first or a second sale) within each period of time.

While this is a very simplified example, it is the essence of how the repeat-sales regression procedure works to construct an index of price changes for each period of time based on realized same-property round-trip investment results (the buy price and the subsequent sell price for each property).

In the above simple numerical example, there were exactly the same number of repeat-sales observations (two, one for Property #1 and one for Property #2) as there were periods of time for which we were trying to estimate the percentage price changes (two years: 2007 and 2008). As a result, there was a single, unique solution to our system of simultaneous equations. In addition, in the above example both of those two repeat-sales observations were exactly consistent with the true underlying annual price changes of 10% in the first period and 0% in the second period.

In the real world, things are not that simple, in two respects. First, the individual repeat-sales observations typically contain random “errors”. The term “errors” here is in quotes, because there is no implication that anyone has done anything wrong or that the prices are not true or correct. It is simply the case that each transaction in a real estate market is between one buyer and one seller (essentially) for a unique property. The price the two parties end up agreeing to will typically be a bit different from the price any other two parties would typically agree to for that property at that time. It is not as if the two parties can consult the publicly reported trading prices of homogeneous shares of the same property trading continuously in a dense, public exchange like the stock market. No one ever knows exactly for certain the market value of any given real estate asset at any given time. Thus, observed transaction prices are randomly distributed around the average price at any given time. This is a source of randomness in index estimation and what is termed “noise” in property price indexes.

Noise exists in any property price index, no matter how the index is constructed. (Noise also exists in time-series of stock returns, only less so, although it can be noticeable in very high-frequency indexes or in returns series of thinly-traded stocks.) We can generally reduce the noise in the index the more data we have, that is, the more repeat-sales observations we have per index reporting period. Noise can also be reduced by using more efficient and effective index construction techniques (as can other types of index estimation error, such as bias).

This brings us to the other way in which the real world is more complicated than the simple numerical example above. In the real world we will typically have more repeat-sales observations (and hence more equations) than time periods for which we want to estimate the price change percentages. (Indeed we must have more observations than time periods, or the regression analysis won't work.) Thus, we will have more equations than unknowns. This is of course good, because it enables us to reduce the noise in the index estimation. But it means that no solution (no set of time-dummy parameter values, that is, no set of periodic percentage price changes) will exactly solve all of the equations. So, a solution rule is applied to pick a particular set of periodic percentage price changes that will be the regression's best estimate of the true underlying price changes. The classical rule for solving (“estimating”) regression models is known as “ordinary least squares” (OLS), and it says that we pick the solution that minimizes the sum of the squared differences between the regression's estimate of the same-property repeat-sales price changes and the actually observed same-property repeat-sales price changes in the data.

This OLS estimation procedure is good. But some modifications and enhancements can be applied to the procedure that result in better repeat-sales index estimation than simple OLS can provide. There are two major enhancements in particular that are widely used in real estate indexes estimated in the academic community, and have come to be somewhat conventional in circumstances like what is presented by the RCA database. We employ these enhancements in the indexes of the invention, and we will briefly describe them here, along with another specification enhancement that will help to make the indexes as up-to-date as possible.

The first enhancement is what is known as “weighted least squares” (WLS). This approach was pioneered by Case and Shiller in their housing index development in the late 1980s. See, K. Case & R. Shiller, “Prices of Single Family Homes Since 1970: New Indexes for Four Cities”, New England Economic Review: 45-56, September/October 1987. The WLS procedure is like OLS, only it weights the observations in the estimation dataset to reflect the likely accuracy of the observations. Observations that are likely to be more accurate indicators of the average same-property price movements in each period are weighted more heavily in the estimation of the index. The weighting is based largely on the length of time between the first and second sales in each observation. The reasoning and methodology behind this enhancement is as follows.

The true (equilibrium) prices of individual assets evolve over time in two ways. First, the individual asset price reflects the evolution of the overall market in which the asset is located. Any news or events that affect the prices of all of the assets in that market in the same general way will be reflected in this type of price evolution of any given individual asset. For example, individual stock prices evolve with the overall stock market, tracking with greater or lesser sensitivity (“beta”) the overall market. Similarly, property asset prices are affected by common factors, such as news about interest rates, the national and local economy, demographic trends, infrastructure developments, and so on—factors that move the entire real estate market in which the property is located.

Second, individual asset prices reflect their own, idiosyncratic circumstances. Some events may largely affect only a single company's stock, or a single property's value. For example, a labor contract agreement in an industrial corporation may affect only that one company's stock; discovery of a faulty roof or HVAC system, or bankruptcy of a small tenant, may only affect the value of that one property. Idiosyncratic price movements are actual, true changes in the prices of real assets, but they are unrelated to the broader market in which those individual assets trade.

To the extent that the price change index seeks to represent the price changes in the market as a whole, that is, the price change in the “average” property in the market, the idiosyncratic evolution of individual property prices, evolution that is (by definition) not correlated with anything else, will tend to add noise or randomness in the estimation of the index. As idiosyncratic price evolution accumulates over time, this type of random component in the price a property is likely to trade for builds up over time. Thus, it is likely that repeat-sales observations that have a longer time span between their first and second sales will have more such idiosyncratic price component, and therefore be less accurate indicators of the actual average same-property price change in each period. The statistical term for this problem is heteroskedasticity. The WLS estimation method corrects for this problem by weighting the repeat-sales observations by a function that declines with the length of time between the two sales.

The specific method by which the WLS weights are determined is to estimate the index through a three-stage regression process. First, the basic OLS regression is run. Then we take the residuals from that regression, that is, the difference in each observation between the price-change percentage predicted by the regression (the OLS-estimated index) and the actual price-change percentage in the observation. We square these residuals, and then perform a second regression of the squared residuals onto the time between the two sales in each observation. The estimated slope parameter from this second regression (the intercept parameter is constrained to be 0) is used to weight the original repeat-sales observations in performing the third-stage WLS regression. Thus, the second stage regression provides the estimate for how much heteroskedasticity exists in each observation.

The second enhancement is known as the “ridge” regression procedure, and it acts as a noise filter that is particularly useful when data to estimate the index is scarce. Unlike simple moving-average smoothing techniques (and unlike appraisal-based indexes), the ridge procedure does not introduce a delay or lag bias into the index. The ridge technique was first developed by Hoerl and Kennard in 1969, but was introduced into the real estate index literature by Goetzmann in 1992. See, A. Hoerl & R. Kennard, “Ridge Regression: Biased Estimation for Non-Orthogonal Problems”, Technometrics 12(1): 55-67, 1969. Also: W. Goetzmann, “The Accuracy of Real Estate Indices Repeat-Sale Estimators”, Journal of Real Estate Finance & Economics 5(1): 5-54, 1992. In the ridge estimation procedure, a small amount of synthetic data is appended to the actual empirical data, providing an anchor to the periodic price change estimates. As applied in the indexes disclosed herein, this procedure introduces a slight bias in the index return estimates (toward zero). But the reduction in noise minimizes the overall randomness in the index. The procedure can be understood as follows.

As originally proposed by Hoerl and Kennard, the ridge procedure can in principle be viewed as an alternative optimization procedure for regression estimation. Just as OLS minimizes the sum of the squared deviations between the regression's estimates of the individual historical data-point values and their actual observed values (residuals), the ridge can be applied in theory to minimize the sum of the squared differences between the regression's estimates of the parameter values and the “true” values of those parameters in a statistical sense. Since, in the repeat-sales regression the parameters represent the index periodic returns that are the primary focus of the index, this type of optimization of the parameter estimation can make more sense than traditional OLS estimation. In applications of regression analysis to real estate index construction, we care more about accuracy in the parameter estimates (the index periodic returns) than about accuracy in predicting the individual property price changes in the historical database. Thus, the ridge procedure makes good sense.

As proposed by Goetzmann, the ridge is typically applied in real estate index construction in a slightly different manner than Hoerl and Kennard originally proposed, though the two approaches are often very similar in practice. The Goetzmann procedure applies the ridge as a so-called “Method of Moments” estimator. What this means is that the ridge is applied so that it minimizes the sum of squared residuals given an exogenously specified constraint in the statistical characteristics of the resulting real estate index. This is what is known as a Bayesian procedure, in which use of a priori knowledge about the phenomenon being analyzed is used to improve the effectiveness of the statistical inference about that phenomenon.

The “moment” that is used to control the ridge estimation in the indexes disclosed herein is the first-order autocorrelation coefficient in the estimated index price-change returns. This statistic is a powerful indicator of the quality of the index. Economic theory tells us that in an efficient asset market, the first-order autocorrelation of the returns should be near zero. (This is the famous “random walk” attribute of stock prices.) The index return in one period should not tell us much about the index return in the next period, at least on average over the long run. In the indexes of the invention the ridge is applied to result in index returns that have near zero first-order autocorrelation in the frequency at which the index is estimated. Thus, for the national all-property index that is estimated at the monthly frequency, the first-order zero-autocorrelation condition holds at the monthly frequency. For the property type sector indexes that are reported at the quarterly frequency, the criterion applies to quarterly returns. In the case of MSA-specific indexes that are reported only at the annual frequency, a more ad hoc rule is employed, because there is insufficient annual history to allow the autocorrelation statistics to be meaningful. For annual indexes, the ridge parameter is set at a fixed value based on a comparison of the resulting historical index to a priori knowledge about the history of the relevant property markets. As with all aspects of the index methodology, the specification of the ridge procedure will be subject to periodic review and modification as appropriate.

Of course, we recognize that real estate markets are not perfectly efficient in this sense. (Neither are stock markets, for that matter.) And price changes are not total investment returns. So, we would not expect the periodic price changes to have perfectly zero autocorrelation, especially over short periods of time. Nevertheless, using the zero first-order autocorrelation criterion provides a good way to apply the ridge estimator in this context. Real estate asset price indexes that display persistent strong negative or positive autocorrelation should be suspect. If a real estate index shows strong negative autocorrelation, that is almost certainly an indication that the index is noisy, containing excessive amounts of randomness or error. If an index displays strong positive autocorrelation, that is suggestive of excessive smoothing and probably a temporal lag bias, as in the case of appraisal-based indexes. The ridge procedure eliminates excess noise without inducing a temporal lag bias. Use of the ridge procedure is of great importance in the construction of commercial real estate price indexes, where transaction data is much scarcer than it is in the housing industry.

In addition to the above two enhancements to the classical OLS index estimation procedure, the indexes disclosed herein employ a modification to the traditional zero/one time dummy-variable specification. This is not a modification to the regression estimation procedure, but merely an enhancement to the specification of the time dummy-variables on the right-hand-side of the regression that estimates the index periodic returns. This modification was first proposed by Bryan and Colwell in 1982, See, Bryan & P. Colwell, “Housing Price Indices”, in C. F. Sirmans (ed.), Research in Real Estate, vol. 2. Greenwich, Conn.: JAI Press, 1982.

In the time-weighted dummy-variable specification the dummy-variables corresponding to each time period in the index history can assume values between zero and one. They still receive the value of zero for any time periods completely before the first sale or completely after the second sale. But for periods that include either one of those sales, the time dummy-variable is given a value equal to the proportion of that period of time during which the property was held by the investor (between the two sales). For periods strictly between the first and second sales (after the period of the first sale and before the period of the second sale), the time dummy variable values are unity, as before.

To make this concrete, let's go back to our original two-property, two-period example presented earlier. Suppose that Property #1 instead of having its first sale exactly at the beginning of 2007, actually transacted at the end of January of that year. And suppose Property #1's second sale was not exactly at the end of 2008, but rather at the end of October, 2008. Then the value of the “X2007” dummy variable for the Property #1 repeat-sale observation would be 11/12 instead of 1, and the value of the “X2008” variable for that observation would be 10/12 instead of 1.

This time-weighted specification causes the index periodic return estimates to be more accurate and up-to-date, better reflecting the actual rate of return that occurred in each historical period. To see this, suppose in a certain market prices gain steadily at a 10%/year rate throughout Year 1, and are exactly flat throughout all of Year 2. Suppose the observed properties are all bought in the middle of Year 1 and sold in the middle of Year 2, and they all track exactly the true market price-change. Thus, all the properties sell for 5% more than what they were bought for (reflecting the second half of Year 1's price increase).

In this situation the traditional zero/one time-dummy specification would result in an index that attributes 0% price increase to Year 1 and only a 5% price increase to Year 2 (because the Year 1 dummy variable would have a value of zero, and the Year 2 dummy variable would have a value of unity, for all of the observations, and we must multiply unity times 5% in order to get the observed 5% price increase).

In contrast, the time-weighted specification would result in an index that attributes 5% price increase to Year 1 and another 5% to year 2 (as 5%*(½)+5%*(½)=5%, for all of the observations). While this also is not perfectly accurate (the truth is 10% in Year 1 and 0% in Year 2), the time-weighted specification gets the total price increase correct (10% across the two years, instead of only 5% with the traditional specification). And the time-weighted specification has only half the temporal lag of the traditional specification. (The true increase occurred entirely in Year 1; the time-weighed index attributes it half in Year 1 and half in Year 2; while the traditional specification attributes it entirely in Year 2.) If sales are more uniformly spread out throughout all the time periods, the time-weighted specification will tend to be more accurate than this simple example illustrates.

In addition to a well-established, rigorous index estimation methodology, construction of a good real estate price index depends vitally on the quality of the empirical data that goes into the estimation process.

The RCA database is widely respected among real estate industry investment practitioners in the U.S., and it is our understanding that RCA is dedicated and committed to always obtaining the best and most extensive commercial property transaction price data possible. Nevertheless, it is inherent in the nature of empirical data that there are issues and occasional errors in individual data points. In the present indexes, this is addressed by the use of data filters that are implemented both at RCA and the index producer. The use of such filters is typical in the construction of empirical real estate price indexes, and the specific filters we employ are similar in nature and purpose to those employed in other widely used indexes, such as the OFHEO and CSW housing indexes. These filters are described below.
I. “Flips” filter. All properties in the index are held for more than 1.5 years. This filter prevents “flipped” properties from entering the index. Evidence from academic research and from analysis of the RCA database suggests that incorporation of properties held for such short periods results in overstatement of market price appreciation. Flipped properties often represent cases in which something has been done to substantially alter the property or its tenancy in a manner that does not reflect the property market, or cases in which the initial purchase price was not an arms-length transaction price. This filter also balances the inherent and unavoidable truncation of observations on the other end of the holding period spectrum. (Properties held for very long times don't tend to make it into the database because they sell so infrequently; to the extent holding period is correlated with performance, it makes sense to introduce a truncation at the short end given that truncation is inevitable on the long end.
II. Portfolio transactions. All properties that are a part of portfolio (multiple-property) transactions are discarded unless both the first and second transaction prices are classified by RCA as either “approximate” or “confirmed”. This ensures that properties transacting as parts of portfolios do not enter the index unless we are able to accurately account for each property's contribution to the portfolio's transaction price.
III. Excessively old data. All properties with first transactions before 1988 are dropped. Before 1988, first transaction data is sparse and this causes problems with the index construction methodology.
IV. Incomplete information. Properties without a property type classification or full location information are dropped, as are properties with one missing transaction price or date.
V. Consistent usage. Properties must be comparable in terms of use and size at the time of the first and second sales. For example, an office building that is converted to apartments and re-sold is not a valid comparison.
VI. Built before first sale. The year built indicated for the property in the second sale must equal or precede the date of the first sale. If not, the prior sale is likely to be the land acquisition cost.
VII. No major change in size. The rentable area of the property can not vary by more than 10% between the two sales.
VIII. Extreme returns filter. A property is not included in the index if its annualized return is less than negative 20% per annum, or greater than a limit that is scaled with the holding period, starting at 50% per annum for holding periods of less than four years between sales, and then gradually decreases asymptotically toward 10% per annum (e.g., is around 12%/year for properties held for 20 years). This filter catches and removes from the estimation database some erroneous price reports and some major development or redevelopment projects or otherwise non-market-representative transactions that have otherwise slipped through the data cleansing and filtering process.

Filter I, the “flips” filter, is imposed for economic reasons (as described). The other filters are aimed primarily at removing faulty or inappropriate data, and eliminating development or redevelopment projects that would not well reflect same-property price changes in the property market. These filters serve to provide an important contribution to the quality and reliability of the index, while minimizing case-by-case subjective human judgment in the data cleansing process. As noted, such filtering is standard in real estate index construction.

Unlike property market price indexes designed primarily for research or academic purposes, the RCA indexes described in this report are designed to support derivative trading in a practical manner. With this in mind, certain protocols regarding the operational production and publication of the indexes have been developed. These protocols will be described in this section, regarding delay of index reporting to allow accumulation of data, regarding a possible indication of relevant income return, and regarding contingencies in the event of insufficient data for specific indexes. In both cases, the specific protocols presented here represent initial policies deemed useful to facilitate the commencement of derivative trading. Like the index methodology described above, these production and publication protocols will be subject to periodic review. The goal is to provide indexes that are the most practical and useful possible for the derivatives marketplace. As noted, this represents a type of “engineering” project, to devise a practical tool for the stated purpose, rather than a purely academic exercise.

We want the index return in a given period to represent as well as is practically possible the change in realized same-property prices up to the end of that period, as evidenced by second-sale transactions actually closed during the period. Yet it takes time for the prices of closed transactions to be recorded and reported, and to be gathered and compiled by RCA, and the derivatives market places a value on timely closing of contracted positions. Experience with the developmental database suggests that within 45 to 75 days of the close of an index reporting period a sufficient quantity of the second-sale transactions that RCA will ultimately gather from the given period will be available for index construction. Based on this consideration, a preferred embodiment involves the following index production and publication protocol. For indexes where the data availability is sufficiently dense (generally, the monthly and quarterly indexes), 45 days would be allowed to elapse after the end of the reporting period to accumulate data for index computation. For indexes where the data availability is less dense (generally the annual indexes), 75 days would be allowed to elapse. In all cases, the index report would be considered to be final once it is published, and any second sales occurring beyond the end of the subject period would be excluded from the index computation (no “backward adjustment”). This protocol would be preferred if the derivatives market prefers to trade only on the first report of a given period's return.

Any such protocols for reporting of the index returns would be aimed at striking a balance between maximizing data usage and providing a base for rapid, real-time closure of trades upon the indexes. The vast majority of the second-sales occurring by the end of the subject period that will ever be in the RCA database will be incorporated within the 75-day window described in the above procedure.

While the main purpose of a property market derivative can be served by a price-change index alone, the marketplace may find useful some indication of the magnitude of the income return in the property market. The income return is the net income generated by the property as a fraction of the property market value. The RCA database can be used to derive such an indication, by examining those sales transaction observations in the database that also have the associated property income or “capitalization rate” (also known as the “cap rate”). The cap rate of a property is its net income divided by its current market value. While the RCA database does not contain this information for all sales observations, there is sufficient such information to derive some indication of income return that may be useful for the derivatives marketplace, at least for some of the price-change indexes.

As noted in our discussion of methodology, any real estate price index will contain some “noise”, or excess randomness. The more second-sale observations available in any given index reporting period, the less such noise is likely to be present. Even though the indexes are based on only and all actual transaction price data that has passed through RCA's data qualification and validation process as well as the filtering screens and the return estimation optimization and noise-control methodology, there can arrive a point of diminishing data availability at which the danger of too much noise becomes large enough that some contingency for such situations has been deemed desirable. The contingency that will be employed in the initial Indexes is described in this section.

The indexes which have been established for initial publication for trading purposes, have been based on the following simple criterion. If the second-sale transaction observation data frequency observed in CY 2005 were to fall by a factor of one-half, there would still be at least approximately 20 observations per quarter for quarterly indexes and 40 observations per year for annual indexes.

The particular criterion of 20 and 40 observations per period as half of the 2005 observation frequency is admittedly ad hoc from a rigorous econometric perspective. This criterion has been set based on the judgment and experience of the inventors herein. The decision to publish an index for the purpose of derivative trading is not to be taken lightly, because once the index commences publication, and contracts are possibly written on it, the publication of the index must continue.

The decision to publish any given set of indexes is naturally a subjective balance between the objective of minimizing noise in any published index return versus the objective of providing the derivatives market with as many “market-specific” indexes as possible. We cannot guarantee that the published indexes will never exhibit noisy or anomalous returns. Nor can we state exactly how frequently, if ever, the criterion values of 20 or 40 observations will be breached.

In the event that any index in any period falls below the criterion data frequency (20 observations for quarterly frequency, 40 for annual frequency), the following procedure has been agreed upon. The subject index will be combined with the same sector index at the next higher level of geographic scope, with the subject index weighted in proportion to the number of observations as a percentage of the criterion amount. Thus, for example, suppose in a given year the New York MSA Office Index has only 30 second-sale observations, which is less than the 40-observation criterion (for an annual index). In that case the New York Office Index will be derived as follows:

NY Off Return=( 30/40)*(Original NY Off Return)+( 10/40)*(East Region Off Return).

While the likelihood of the need to use this contingency protocol is considered small, derivative traders writing contracts on these indexes must be aware of this policy and must take it in consideration when they write their contracts. Commercial real estate markets tend to be strongly pro-cyclical in transaction volume. During a severe market downturn, transaction volume, and hence price observations, could fall substantially from recent levels. On the other hand, RCA continues to increase its scope and depth of data collection, and it is in the inherent nature of repeat-sales databases to grow substantially in the early years, as properties are typically held on average 10 years between sales.

It is important to note that the criterion values of 20 or 40 observations per period are not “magic numbers”. As noted, it is not impossible for an anomalous or spurious return to occur even when there is more data than this, nor is it necessarily the case that returns reported with less than the criterion data will be anomalous. In our experience, the indexes can behave reasonably even with less than the criterion amount of data. Any published index report will be based on actual same-property price changes insofar as is reasonably possible to eliminate any data errors, and based on ALL of the available data (net of the previously-described data filters).

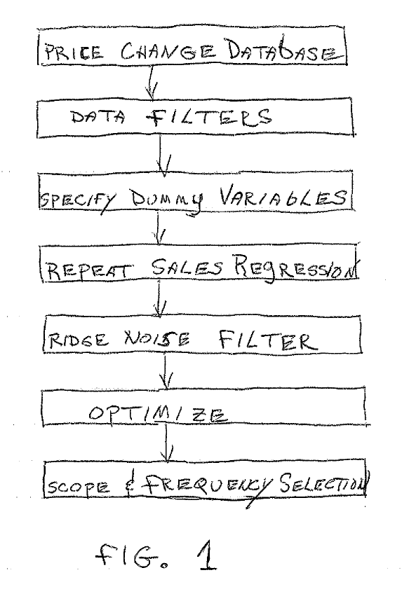

The steps of the invention are illustrated in FIG. 1. First of all, a price change database 10 is utilized. A suitable database has been developed by Real Analytics, Inc. of New York. It is to be understood that other repeat-sales databases can be used. The database is filtered with data filters 12. Dummy variables 14 are specified and a repeat sales regression 16 is performed on the filtered database to create an index. The repeat sales regression 16 includes a weighted least squares estimation in which weights are determined in a three-stage regression process and a ridge regression noise filter 18 is provided in which a first order autocorrelation coefficient in estimated index price-change returns controls the ridge estimation. The first order autocorrelation coefficient is near zero. The index is optimized 20 for derivative trading purposes by excluding backward adjustments and a scope and frequency 22 for the index is selected.

Those of ordinary skill in the art will recognize that the commercial real estate price change index disclosed herein will be useful in supporting tradable derivatives. See, U.S. Published Application No. U.S. 2005/0075961, the contents of which are incorporated herein by reference.

It is recognized that modifications and variations of the invention disclosed herein will be apparent to those of ordinary skill in the art and it is intended that all such modifications and variations be included within the scope of the appended claims.

What is claimed is:

1. Method for establishing a commercial real estate price change index supporting tradable derivatives comprising:
utilizing a database of price changes actually experienced by individual commercial properties including allowing for gradual accumulation of price data;
filtering the database with selected data filters;
specifying time-weighted dummy variables;
performing a repeat-sales regression on the filtered database to create the index, the repeat sales regression including a weighted least squares estimation in which weights are determined in a three-stage regression process, and a ridge regression noise filter in which a first order autocorrelation coefficient in estimated index price-change returns controls the ridge estimation, the first order autocorrelation coefficient being near 0;
optimizing the index for derivative trading purposes by excluding backward adjustments; and
selecting a scope and frequency for the index.

2. The method of claim 1 wherein the data filters are selected from the group comprising Flips filter, portfolio transactions, excessively old data, incomplete information, consistent usage, built before first sale, no major change in size, extreme returns filter.

3. The method of claim 1 wherein the dummy variables assume values between 0 and 1.

4. The method of claim 3 wherein the time-weighted dummy variable has a value equal to the proportion of the period of time during which a property was held by an investor between two sales.

5. The method of claim 1 wherein the three-stage regression process comprises:
running an ordinary least squares regression;
finding residuals from the regression;
squaring these residuals;
performing a second regression of the squared residuals;
estimating a slope parameter from the second regression (constraining the intercept parameter to be 0); and using the estimated slope parameter to weight original repeat-sales observations in performing a third-stage weighted least squares regression.

6. The method of claim 1 wherein the ridge regression noise filter appends a small amount of synthetic data to actual empirical data thereby providing an anchor to periodic price change estimates.

7. The method of claim 1 wherein the price change index reflects only price changes implied by realized investments thereby eliminating a problem of backward adjustments.

8. The method of claim 1 further including publishing four staggered seasonal versions of an annual index.

9. The method of claim 1 further including publishing an approximation of an income return component useful for combining with the price index to aid in derivative contract development.

10. The method of claim 1 further including establishing a period of time at the end of a reporting period to accumulate data for index computation.
